(19) United States
(12) Patent Application Publication
(10) Pub. No.: US 2007/0069689 A1
(43) Pub. Date: Mar. 29, 2007

(54) Battery charger

(76) Inventor: King Mo Shum, Kowloon (HK)

Correspondence Address: Edward G. Greive;Renner, Kenner, Greive, Bobak, Taylor & Weber, Fourth Floor, First National Tower, Akron, OH, 44308-1456, US

(21) Appl. No.: 11/518,044

(22) Filed: Sep. 8, 2006

Related U.S. Application Data
(60) Provisional application No. 60/721,338, filed on Sep. 27, 2005.

(51) Int. Cl. H02J 7/00

(52) U.S. Cl. 320/114

(57) ABSTRACT

A battery charger for charging one or more rechargeable batteries. One or more rechargeable batteries are placed into one or more charging areas of the battery charger. Each of the one or more charging areas has a positive charging plate and a negative charging plate and is configured to receive a battery. The battery charger includes a charging circuit coupled to the positive charging plate and the negative charging plate of each charging area, the charging circuit configured to provide a charging current through the positive charging plate and the negative charging plate of each charging area, the charging circuit further including a microcontroller configured to receive a detection signal and adjust the charging current in response to the detection signal. In one embodiment, the battery charger detects the presence of an AAA size battery and adjusts the charging current.

### CROSS-REFERENCE TO RELATED APPLICATION

This application claims the benefit of U.S. Provisional Application No. 60/721,338 filed Sep. 27, 2005.

### TECHNICAL FIELD

The present invention relates generally to a battery charger, and more specifically, a battery charger for charging multiple sizes of rechargeable batteries.

### BACKGROUND ART

Due to the widespread use of electronic products (e.g. personal digital assistants (“PDA”), digital cameras, mp3 players, etc.), the use of rechargeable batteries, especially of the double-A (“AA”) and triple-A (“AAA”) size, as a power source for these and other products has also become widespread.

When traveling, people want to have a small and inexpensive battery charger which can charge rechargeable batteries of multiple sizes, such as both AA and AAA size, for the use with their electronic products. There are many battery chargers available in market that can charge both AA and AAA size batteries. However, there are limitations to the presently available battery chargers.

Accordingly, there remains a need for a battery charger that can satisfy the requirements of the consumer by providing a battery charger which has a small size, is capable of charging AA and AAA size batteries, and is available at a low cost.

### DISCLOSURE OF THE INVENTION

According to one embodiment of the present invention, a battery charger for charging one or more rechargeable batteries is disclosed. The battery charger includes a charger body; one or more charging areas in the charger body, each of the one or more charging areas having a positive charging plate and a negative charging plate, each of the one or more charging areas configured to receive a battery between the positive charging plate and the negative charging plate such that the positive charging plate contacts the positive terminal of the battery and the negative charging plate contacts the negative terminal of the battery; and a charging circuit coupled to the positive charging plate and the negative charging plate of each of the one or more charging areas, the charging circuit configured to provide a charging current through the positive charging plate and the negative charging plate of each charging area, the charging circuit further includes a microcontroller configured to receive a detection signal and adjust the charging current in response to the detection signal.

According to another embodiment, the charger body of the battery charger includes at least two charging areas and the charging circuit includes a charging channel having at least two charging sections connected in series. In one embodiment, the charging channel includes a current control switch.

According to another embodiment, the negative charging plate of each charging area is selectively slidable between a first position, a second position, and a third position, and the negative charging plate of each charging area is in the first position when no battery is located in the charging area, in the second position when an AA size battery is located in the charging area, and in the third position when an AAA size battery is located in the charging area, and wherein the detection signal is generated when the negative charging plate of at least one of the one or more charging area is in the third position.

According to one embodiment, the detection signal is generated by a voltage change in the charging circuit. According to another embodiment, the detection signal is received by the microcontroller in response to a voltage change in the charging circuit. According to yet another embodiment, the detection signal includes detecting a voltage change in the charging circuit.

According to another embodiment, the battery charger includes a cover coupled to the charger body, the cover pivotable between an open position and a closed position, wherein in the closed position the cover forms an enclosure with the charger body, the positive charging plate and the negative charging plate of each of the one or more charging areas within the enclosure.

According to another embodiment, the charger body of the battery charger has an AC plug for coupling to an electrical outlet; and one or more plug adapters configured for alternative coupling to the AC plug, wherein each of the one or more plug adapters is alternatively electrically connected to the AC plug.

According to yet another embodiment of the present invention, a battery charger for charging one or more rechargeable batteries is disclosed. The battery charger includes a charger body having means for receiving one or more batteries; means for delivering a charging current to the one or more batteries in series, the delivery means including a control means for controlling the delivery of the charging current to the one or more batteries; means for detecting the presence of an AAA size battery in the battery charger; and means for adjusting the charging current delivered to the one or more batteries in response to detecting the presence of an AAA size battery in the battery charger.

It is to be understood that other aspects and advantages of the present invention will be readily apparent to those skilled in the art from the following detailed description, wherein example embodiments of the invention are shown and described by way of illustration. The invention is capable of other and different embodiments, and its several details are capable of modification in various respects, all without departing from the scope of the invention. Accordingly, the drawings and description are to be regarded as illustrative in nature and not restrictive.

### BRIEF DESCRIPTION OF THE DRAWINGS

These and other features, aspects, and advantages of the present invention will become better understood with regard to the following description and accompanying drawings where:

FIG. 1A is a circuit diagram of a charging circuit, in accordance with an embodiment of the present invention.

FIG. 1B is a detailed circuit diagram, including the charging circuit of FIG. 1A, in accordance with an embodiment of the present invention.

FIG. 2 is a perspective view diagram illustrating the American National Standard Institute (“ANSI”) and Japanese Industrial Standard (“JIS”) dimensions for an AA and AAA size battery.

FIG. 3A is a perspective front view of a battery charger with the cover closed, in accordance with an embodiment of the present invention.

FIG. 3B is a perspective front view of the battery charger shown in FIG. 3A with the cover open and without any rechargeable batteries placed in the battery charger, in accordance with an embodiment of the present invention.

FIG. 4A is a perspective front view of the battery charger shown in FIG. 3A with the cover open and one AA size rechargeable battery placed in the battery charger, in accordance with an embodiment of the present invention.

FIG. 4B is a perspective front view of the battery charger shown in FIG. 3A with four AA size rechargeable batteries placed in the battery charger, in accordance with an embodiment of the present invention.

FIG. 4C is a perspective front view of battery charger shown in FIG. 3A with the cover open and one AAA size rechargeable battery placed in the battery charger, in accordance with an embodiment of the present invention.

FIG. 4D is a perspective front view of the battery charger shown in FIG. 3A with one AA size rechargeable battery and one AAA size rechargeable battery placed in the battery charger, in accordance with an embodiment of the present invention.

FIG. 5A is a perspective rear view of the battery charger shown in FIG. 3A with the AC plug folded in a storage position, in accordance with an embodiment of the present invention.

FIG. 5B is a perspective rear view of the battery charger shown in FIG. 3A with the AC plug unfolded into a use position, in accordance with an embodiment of the present invention.

FIG. 5C is a front view of the battery charger shown in FIG. 3A with the cover closed, in accordance with an embodiment of the present invention.

FIG. 6A is a cross-sectional side view of the battery charger shown in FIG. 5C, taken along the section line A-A, showing the structure of the charging area without a battery placed in the battery charger, in accordance with an embodiment of the present invention.

FIG. 6B is a cross-sectional side view of the battery charger shown in FIG. 5C, taken along the section line A-A, showing the structure of the charging area with an AA size battery placed in the battery charger, in accordance with an embodiment of the present invention.

FIG. 6C is a cross-sectional side view of the battery charger shown in FIG. 5C, taken along the section line A-A, showing the structure of the charging area with an AAA size battery placed in the battery charger, in accordance with an embodiment of the present invention.

FIG. 7A is a perspective front view of multiple AC plug adapter configurations for use with the battery charger shown in FIG. 3A, in accordance with an embodiment of the present invention.

FIG. 7B is a perspective rear view of multiple AC plug adapter configurations for use with the battery charger shown in FIG. 3A, in accordance with an embodiment of the present invention.

FIG. 8 is a perspective front view of the battery charger shown in FIG. 3A with a UK plug adapter attached, in accordance with an embodiment of the present invention.

### PREFERRED EMBODIMENT FOR CARRYING OUT THE INVENTION

The detailed description set forth below in connection with the appended drawings is intended as a description of example embodiments of the present invention and it is not intended to represent the only embodiments in which the present invention can be practiced. The embodiments described throughout this description are intended to serve as examples or illustrations of the present invention and should not necessarily be construed as preferred or advantageous over other embodiments. Any number of the described embodiments may be incorporated in any desired combination. The detailed description includes specific details for the purpose of providing a thorough understanding of the present invention. However, it will be apparent to those skilled in the art that the present invention may be practiced without these specific details.

In the following description, reference is made to the accompanying drawings, which form a part hereof, specific embodiments of the invention being shown by way of illustration. It is to be understood that other embodiments may be used as structural and other changes may be made without departing from the scope of the present invention.

Generally, one embodiment of the present invention provides for a battery charger having automatic current selection. In one embodiment, the battery charger determines the size of the battery placed in the battery charger and selects the charging current accordingly. In one embodiment, when it is determined that no AAA size batteries are placed in the battery charger, a current level suitable for charging AA size batteries is used. However, when it is determined that one or more AAA size batteries are placed in the battery charger, the charging current will be set to a smaller current in order to prevent overcharging. In one embodiment, charging is terminated according to an internal timer.

Generally, another embodiment of the present invention provides for charging one or more batteries of multiple sizes in series using a common, or main, control switch or device. Another embodiment of the present invention provides for a pivotable cover. Another embodiment of the present invention provides for a plurality of alternately, removably attachable plug adapters.

Power-Loss is relevant to charging batteries in a battery charger. Generally, in an electronic circuit, there are 2 formulas which represent the Power-Loss:
PL=V·?l Formula A
PL=l2·?R Formula B
Where: PL is the Power-Loss in the circuit;
V=Voltage across the components where Power-Loss occurred;
I=Current that flows through the components where the Power-Loss occurred; and
R=Resistance of the components where Power-Loss occurred.

As shown from the above formulas, current (I) is the main factor attributes to the Power-Loss.

There are two methods of charging multiple batteries, either charging in series or charging in parallel. When charging in series, the current running through each battery is equal to the current in the circuit. For example, the current in circuit is l, which is equal to l1 (current through first battery), which is equal to l2 (the current through the second battery). When charging in parallel, the current in the circuit is l, which is equal to l1 +l2.

Therefore, when charging two batteries, each with the same charging current (i.e. l1=l2), the resulting current in the circuit when charging in series will be smaller than the current when charging in parallel. Accordingly, charging in series can reduce the power loss in the electronic circuit.

There are two methods of control when charging in series. One main control switch can be used to control the charging current through 2 or 4 batteries, or even a larger number of batteries. Using only one switch also allows the cost to be kept low.

When each battery charged is to be controlled individually, each battery charged requires an additional switch to control the charging current. Therefore, more switches are required to control the charging of two or more batteries when using individual control method. The cost is therefore higher when compared to using single switch control method.

However when AA and AAA size batteries are charged together in series using single switch control method, the AAA batteries have a risk of being overcharged. Therefore, when an AAA size battery is located in the battery charger, a lower current may be used for charging to reduce or eliminate the risk of overcharging the AAA battery.

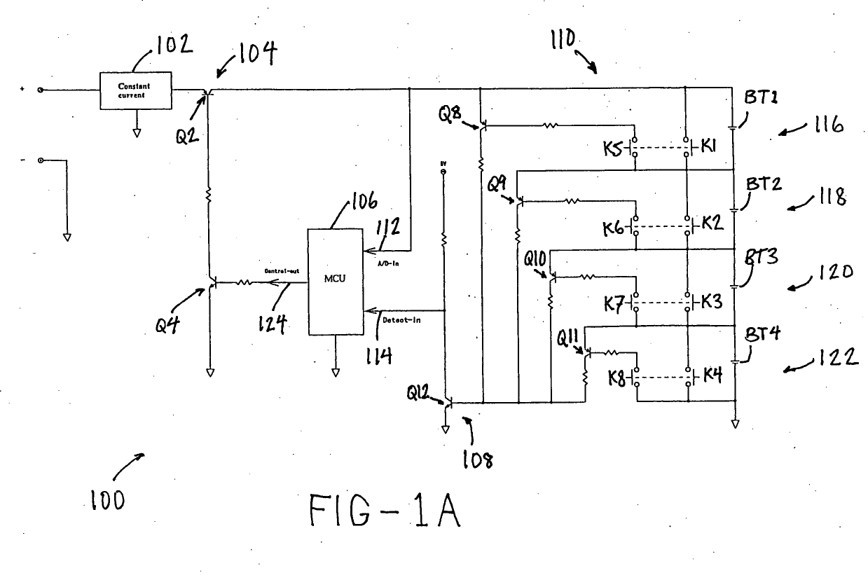

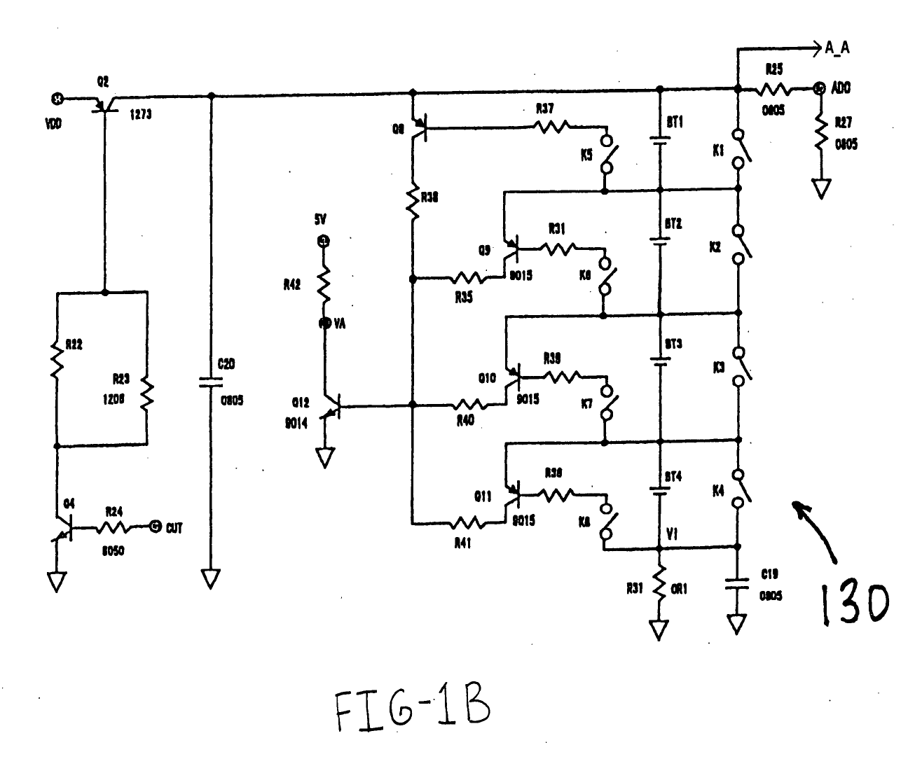

FIG. 1A is a circuit diagram of a charging circuit, in accordance with an embodiment of the present invention. The illustrated embodiment of the charging circuit 100 includes the following elements: a constant current source 102, a charging control section 104, a microcontroller 106, a battery size detector 108, and charging terminal section 110. The charging circuit 100 may be included in a battery charger built in accordance with embodiments of the present invention.

In one embodiment, the constant current source 102 regulates the charging current and maintains the current at a generally constant level. The charging control section 104 includes two switches, Q2 and Q4. The switches Q2 and Q4 control the flow of the charging current (i.e. turns it on/off). When charging one or more AAA size batteries, the charging current is reduced to lower level by regulating the on/off ratio/duty cycle of switches Q2 and Q4. One function of the microcontroller 106 is to control the charging control section 104 according to the status of the battery voltage read from A/D-In 112 or the battery size detection signal read from Detect-In 114 during charging. The charging terminal section 110 includes four switches K1, K2, K3, and K4, and also contact terminals used for making contact with batteries when they are located in the battery charger. The charging circuit 100 therefore illustrates a charging channel that generally includes the charging control section 104 and the charging terminal section 110. The charging circuit further includes a first charging section 116, a second charging section 118, a third charging section 120, and a fourth charging section 122. In one embodiment, each of the charging sections includes similar components. For example, each of the charging sections may include a pair of charging terminals for receiving a battery. In one embodiment, the first charging section 116 may include switches K1 and K5, switch Q8, and battery BT1; the second charging section 118 may include switches K2 and K6, switch Q9, and battery BT2; the third charging section 120 may include switches K3 and K7, switch Q10, and battery BT3; and the fourth charging section 122 may include switches K4 and K8, switch Q11, and battery BT4.

The battery size detector 108 may include switches K5, K6, K7, and K8, and switches Q8, Q9, Q10, and Q11. In one embodiment, switches K5, K6, K7, and K8 are incorporated into the charging terminals in the battery charger. The charging terminal section 110 and the battery size detector 108 operate together to complete the charging circuit and perform the battery size detection and current selection. When placed in the charger, the batteries are shown as battery one BT1, battery two BT2, battery three BT3, and battery four BT4.

Switches Q2, Q4, Q8, Q9, Q10, Q11, and Q12 are shown in the illustrated embodiments and referred to in the description as transistors. However, Q2, Q4, Q8, Q9, Q10, Q11, and Q12 may be any suitable component that performs the described function such as, for example, a switch, a transistor, a MOSFET (metal-oxide semiconductor field-effect transistor), or any other similar component.

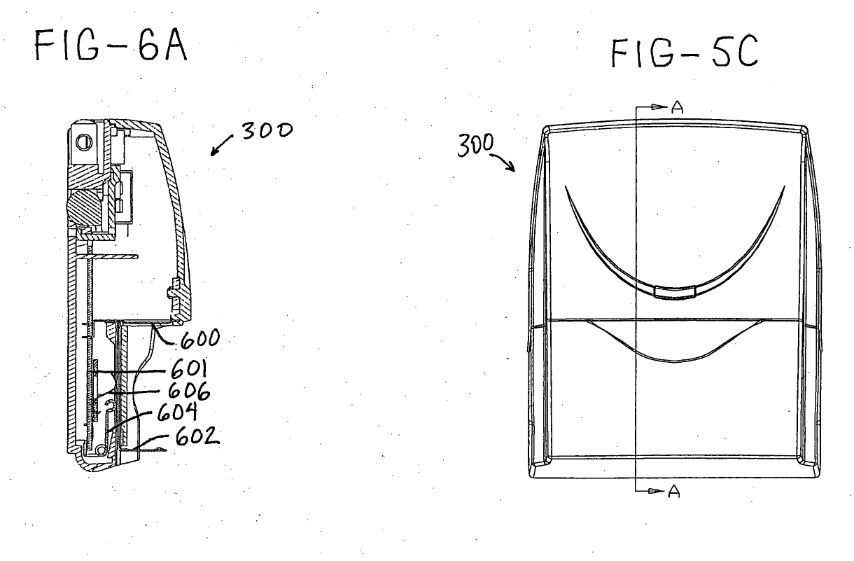

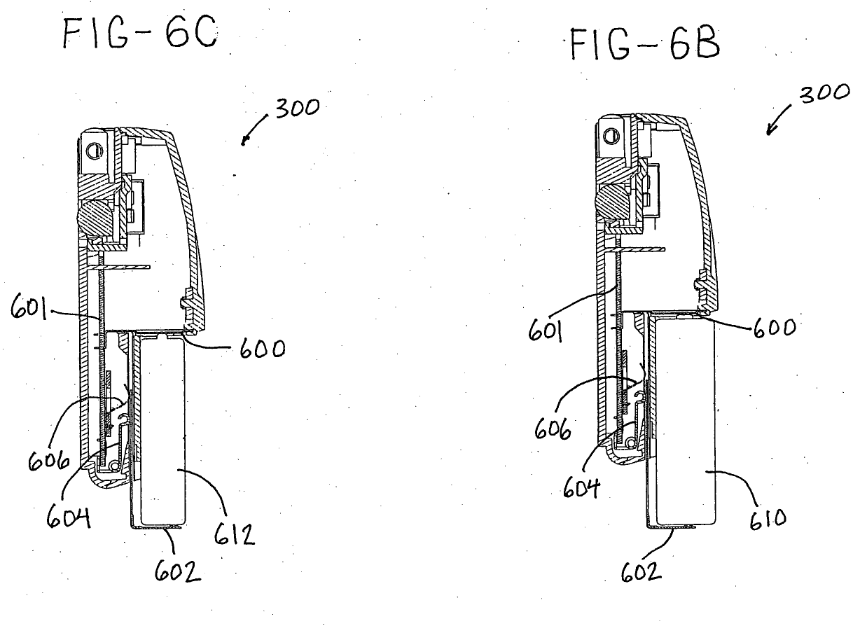

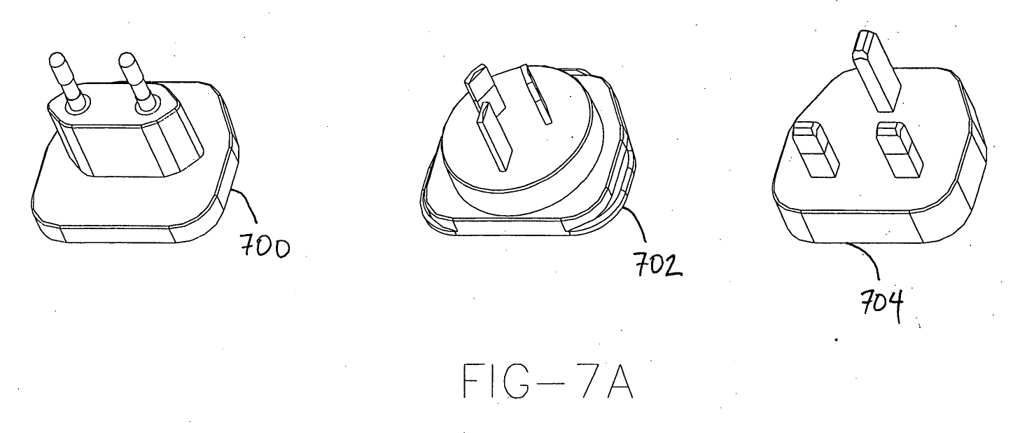

According to one embodiment of the invention, the charging circuit operates according to the following description. In one embodiment, charging terminals in the battery charger comprise at least part of the switches K1, K2, K3, and K4. For example, in one embodiment, each of the switches K1, K2, K3, and K4 includes a positive terminal end and a negative terminal end. When the positive terminal end and the negative terminal end are touching, or making conductive contact with each other, the switch is closed. When the positive terminal end and the negative terminal end are not touching, or not making conductive contact with each other, the switch is open. Switches K1, K2, K3, K4 are closed when no batteries are placed in the charging areas of the battery charger. When no battery is placed in a charging area, the positive and negative ends of the charging terminal are in contact, and the switch is thereby closed. When a battery, of either AA or AAA size, is placed in the charging area, the positive and negative ends of the charging terminal are moved out of contact and the switch is thereby open. Referring to the first charging section 116 as an example, when no battery is placed in the charging area, K1 is closed to form a conductive path. When a battery, of either AA or AAA size, is placed into the charging area, between the negative end and the positive end of the charging terminal, K1 is opened. If at the same time no batteries are placed in the second charging section 118, the third charging section 120, and the fourth charging section 122, switches K2, K3 and K4 will all be closed and form a conductive path. In this situation, the charging circuit includes BT1 (battery one), K2, K3 and K4, and the battery charger will charge battery BT1. When a second battery is inserted, for example, into the second charging section 118, switch K2 will be open as well, and K3 and K4 will remain closed. In this second situation, the charging circuit includes BT1, BT2 (battery two), K3, and K4, and the battery charger will charge batteries BT1 and BT2. In this way, the switches K1, K2, K3, and K4 serve the dual function of being the charging terminals as well as the switches. The physical structure of the charging terminals, and therefore also the operation of switches K1, K2, K3, and K4, are described in additional detail with reference to FIGS. 6A, 6B, and 6C.

The charging circuit operates as described above when one or more batteries are located in the battery charger. Any number of batteries may be located in any of the charging sections in any desired combination. Different types of batteries may be located in the battery charger in any desired combination. For example, a user may place, or insert, one AA size battery and three AAA size batteries, or one AA size battery and two AAA size batteries, or two AA size batteries and two AAA size batteries, and all other possible combinations. Also, while the charging circuit illustrated in FIG. 1A includes four charging sections, any desired number of charging sections may be practiced in accordance with embodiments of the present invention.

Switches K5, K6, K7, and K8 are also closed when no batteries are located in the charging sections of the battery charger. They are different from K1, K2, K3 and K4 in that each of K5, K6, K7, and K8 is also closed when an AAA size battery is located in its respective charging section. However, each of K5, K6, K7, and K8 is open when an AA size battery is located in its respective charging section. The physical structure of the charging terminals, and therefore also the operation of switches of K5, K6, K7, and K8, are described in additional detail with reference to FIGS. 6A, 6B, and 6C.

The operation of battery size detection and current selection is described with reference to the first charging section 116. When there is no battery in the first charging section 116 (i.e. K1 is closed and conducting), the difference between the voltage across the terminals of BT1 is zero. Although at this time K5 is also closed and conducting, the voltage between the emitter and the base, or the emitter to base voltage (“V_{EB}”) of transistor Q8 is zero, and transistor Q8 is off. Therefore, transistor Q12 is also off. When an AAA size battery is inserted into the first charging section 116, and switch K1 is open, since K5 remains closed and is still conducting, the AAA size battery (BT1) gives rise to a voltage difference between the emitter and the base of transistor Q8, referred to as a rise or a voltage change in the V_{EB} of transistor Q8, which turns on transistor Q8, which in turn turns on transistor Q12. When transistor Q12 is on, the microcontroller 106 receives a AAA size battery detection signal from Detect-In 114. Upon receiving the signal, the microcontroller 106 then regulates the Control-out signal 124 to the charging control section 104 to produce a smaller charging current. When a AA size battery is inserted into the first charging section, and switch K1 is open, since switch K5 also becomes open, the V_{EB} of transistor Q8 becomes zero, and the V_{EB} of transistor Q12 also become zero. Therefore, transistors Q8 and Q12 are off, and no AAA size battery detection signal is received by the microcontroller 106.

The AAA size battery detection signal, also referred to as “the detection signal” or “the battery detection signal,” may be generated and detected in the charging circuit 100 using any suitable method. In one embodiment, the detection signal may include the detection of a voltage change in the charging circuit. In another embodiment, the detection signal is generated in response to the detection of a voltage change in the charging circuit. In another embodiment, the detection signal may include the detection of a voltage change in the V_{EB} of transistor Q8. In another embodiment, the detection signal may include the detection of a voltage change in transistor Q12 or any other suitable component in the charging circuit 100. The detection signal may also be any other signal generated to signal the presence of the AAA size battery in the battery charger.

Each of the second charging section 118, the third charging section 120, and the fourth charging section 122 operates similar to the operation described above with referenced to the first charging section 116. There exists a logical “or” relationship between transistor Q12 and transistors Q8, Q9, Q10, and Q11. Therefore, when an AAA size battery is located in any one of the charging sections, or in more than one of the charging sections, transistor Q12 will be turned on such that the microcontroller 106 receives an AAA size battery detection signal, and in response, sets the charging current to a smaller level. In one embodiment, the amount of time a battery, or batteries, is or are charged is determined according to an internal timer. The timer may be configured to measure any suitable length of time. Other suitable methods of regulating the amount of charging time may also be used.

One example of a switch suitable for use as Q2 is a PNP transistor, type No. KTA1273. One example of a switch suitable for use as Q4 is a NPN transistor, type No. KTC8050. One example of a switch suitable for use as Q8, Q9, Q10, and Q11 is a PNP transistor, type No. KTC1504. One example of a switch suitable for use as Q12 is a NPN transistor, type No. KTC3875. These example transistors are available from Korea Electronics Co. Ltd., as well as from any other manufacturer which produces these or equivalently suitable transistors. One example microcontroller suitable for use with embodiments of the present invention is available from Sino Weather, type No. SH69P48. In another embodiment, other suitable components, or a combination of suitable components, may perform the function of the microcontroller. The above manufacturer names and product types are given as examples only and are not intended to be the only components used with embodiments of the invention. Any other components or devices suitable for performing the herein described functions may be used.

FIG. 1 B is a detailed circuit diagram, including the charging circuit 100 of FIG. 1A, in accordance with an embodiment of the present invention. The illustrated detailed circuit diagram is one example of a circuit that may be used with a battery charger built according to embodiments of the present invention. The charging circuit 100 illustrated in FIG. 1A, with any necessary variations made for incorporation into the detailed circuit, is indicated generally by reference number 130.

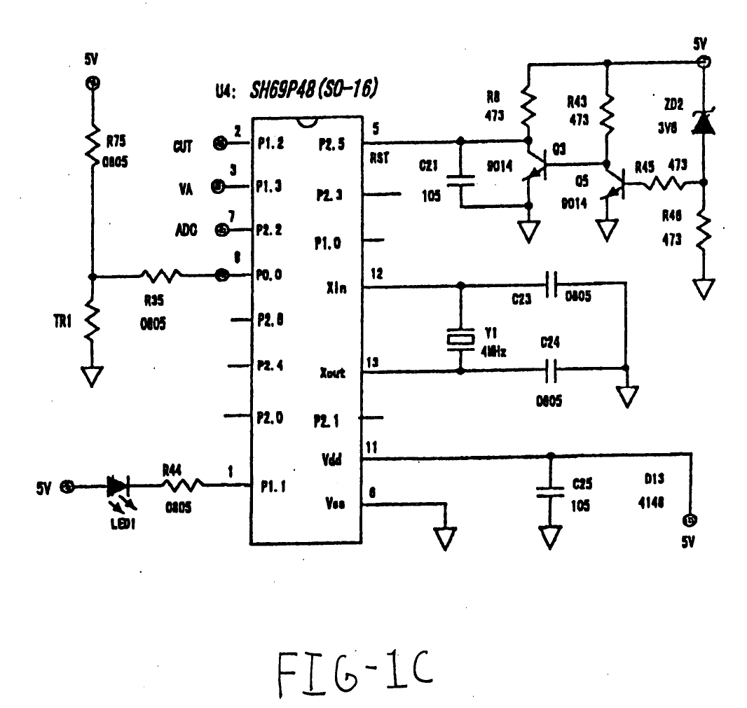

FIG. 2 is a perspective view diagram illustrating the American National Standard Institute (“ANSI”) and Japanese Industrial Standard (“JIS”) dimensions for an AA and AAA size battery. The AA size battery 202 is shown with both JIS and ANSI dimensions. The AAA size battery 204 is shown with both JIS and ANSI dimensions.

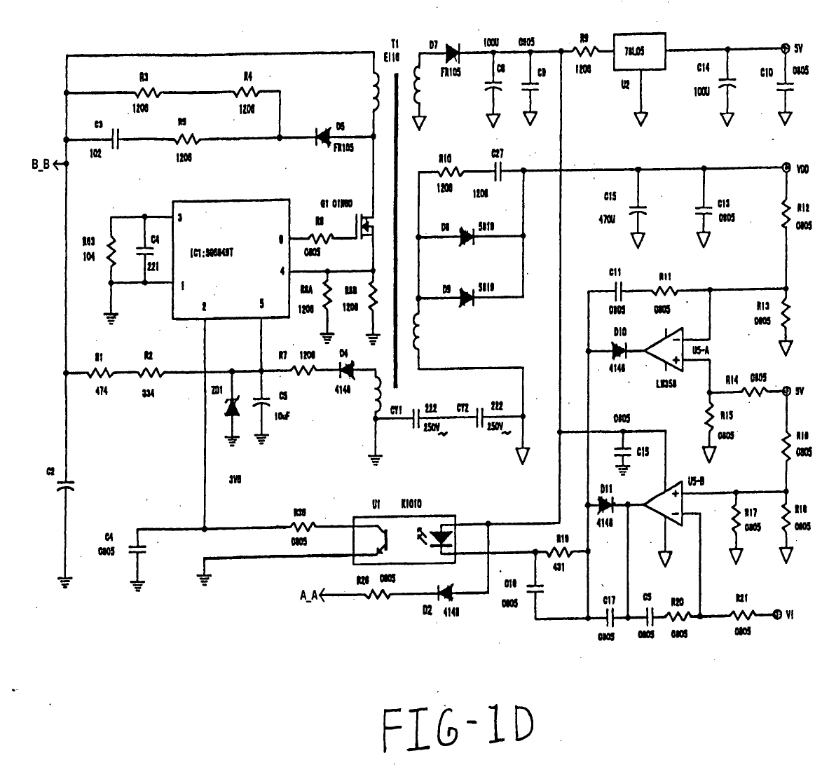

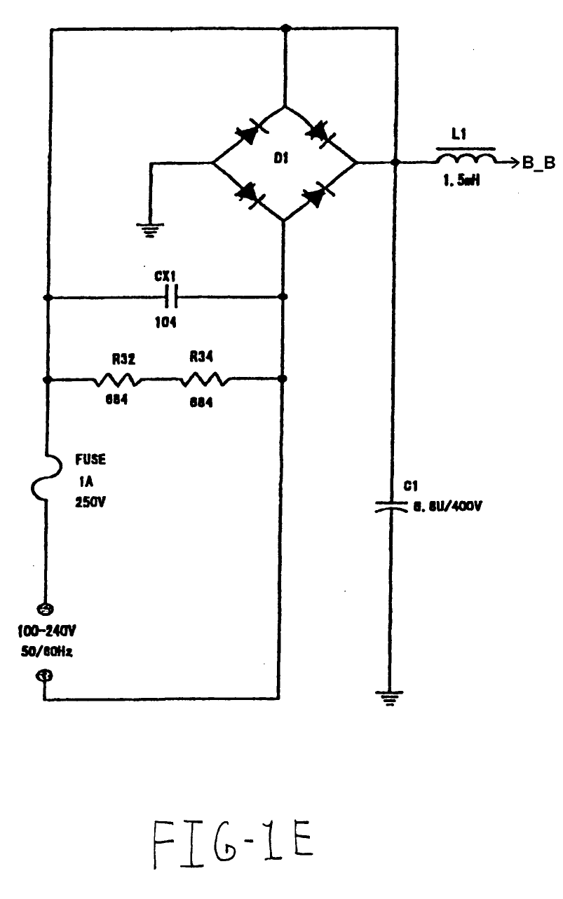

FIG. 3A is a perspective front view of a battery charger with the cover closed and without any rechargeable batteries placed in the battery charger, in accordance with an embodiment of the present invention. The battery charger 300 shown includes a body 302 and a cover 304. In one embodiment, the battery charger 300 may include ornamental features 306, such as a curved shape molded into the body 302, and a light 308, such as an LED indicator to alert the user that the charger is on. The body may be made from molded plastic. In one embodiment, the body includes two portions, a front panel and a rear panel, each panel of complementary size and shape such that they may be joined together to form an enclosure.

FIG. 3B is a perspective front view of the battery charger shown in FIG. 3A with the cover open and without any rechargeable batteries placed in the battery charger, in accordance with an embodiment of the present invention. The battery charger 300 is shown having a body 302 with the cover 304 in an open position. Indicated generally, the battery charger 300 includes four charging areas, a first charging area 310, a second charging area 312, a third charging area 314, and a fourth charging area 316. Also illustrated are a negative charging plate 318 and a positive charging plate 320 of the first charging area 310, a negative charging plate 322 and a positive charging plate 324 of the second charging area 312, a negative charging plate 326 and a positive charging plate 328 of the third charging area 314, and a negative charging plate 330 and a positive charging plate 332 of the fourth charging area 316. Each pair of the negative charging plate and the positive charging plate in each of the charging areas comprises a charging terminal for that charging area, the negative charging plate being a negative end of the charging terminal and the positive charging plate being a positive end of the charging terminal. While the charging plates are shown as “plates” or pieces of generally rigid or resilient metal material, each of the charging plates may be any suitable contact or conductor that is suitable for providing a charging current to the battery and may be included in the charging circuit 100.

The term “charging area” is intended to identify a location in the battery charger 300 that is configured to receive a battery. Each charging area may be configured in any suitable shape or size for the particular batteries being received. For example, the charging area may have the shape of a channel, a groove, a slot, or other shape. In one embodiment, each charging area includes a semi-circular shaped groove, the semi-circular curve corresponding generally to the circular shape of a cylindrical battery. In one embodiment, the battery charger 300 includes four semi-circular shaped grooves aligned generally parallel and adjacent to each other. However, each of the charging areas need not occupy any shape at all and the term “charging area” may refer solely to a location where a battery may be received into the battery charger 300 for charging. In one embodiment, each charging area includes no physically distinguishing features and provides no physical separation or other identifiable boundary between charging areas; the charging area being only a location where the battery may be received in the battery charger 300.

The first charging area 310, the second charging area 312, the third charging area 314, and the fourth charging area 316 of the battery charger 300 correspond generally to the first charging section 1 16, the second charging section 118, the third charging section 120, and the fourth charging section 122 of the charging circuit diagram shown in FIG. 1A, respectively. However, it is not necessary for a particular physical location in the battery charger to necessarily correspond to a specific charging section of the charging circuit diagram. The correlation of physical charging areas to logical charging sections of the charging circuit is primarily for illustration purposes and such description is not intended to identify a specific required configuration. The number of physical charging areas in the battery charger may correspond generally to the number of logical charging sections in the charging circuit. The particular correlation of physical charging areas to logical charging sections of the charging circuit may vary depending on the particular design and the needs of the contemplated use.

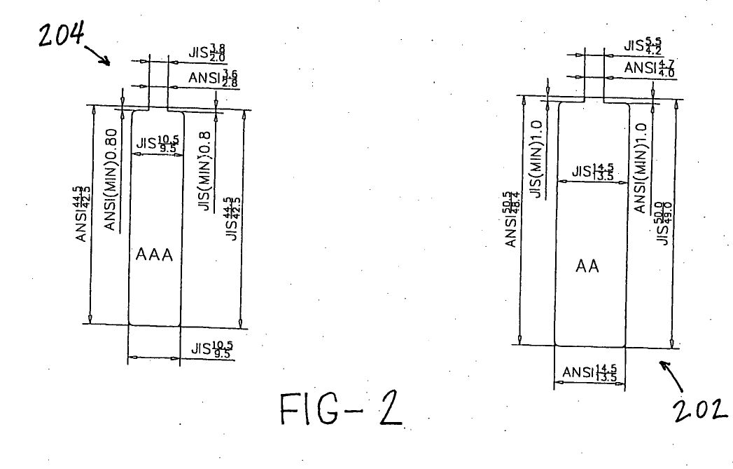

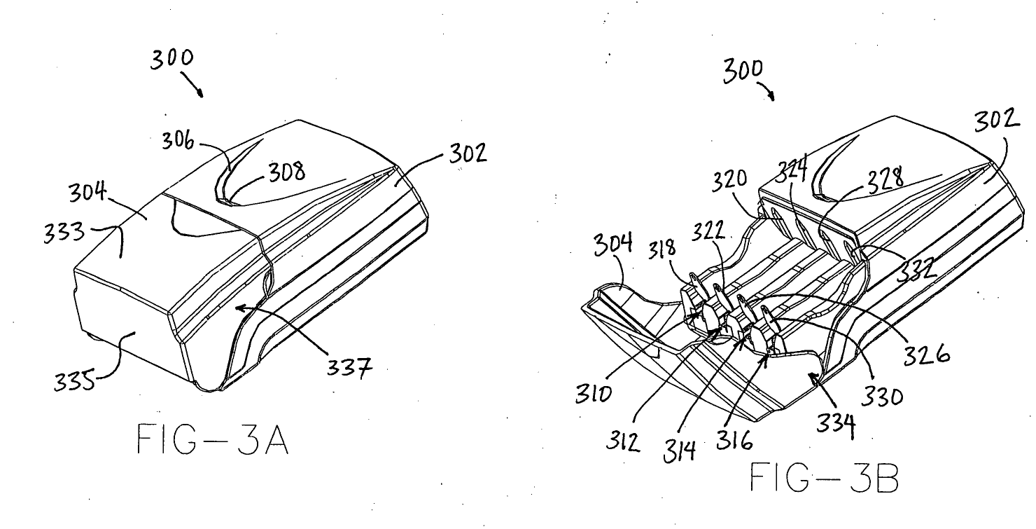

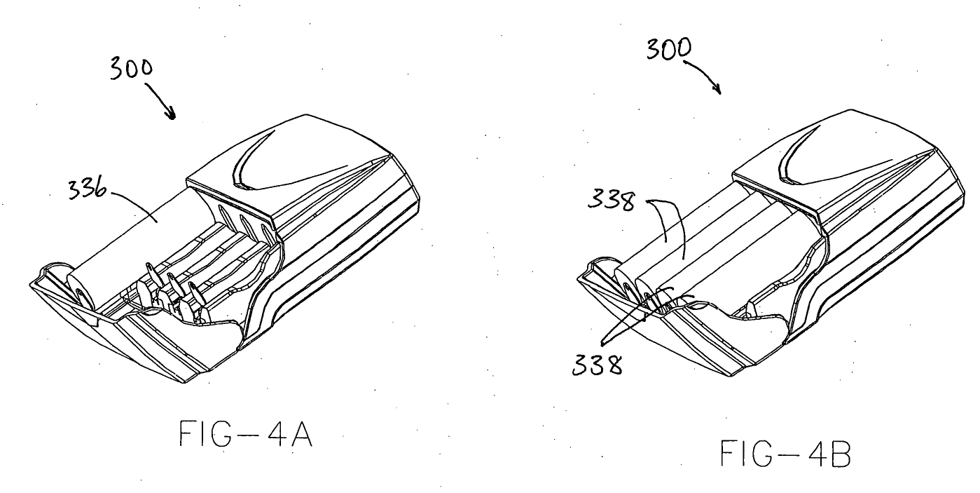

The cover 304 is foldable and may rotate, or pivot, between a closed position, which generally encloses the battery compartment where the charging terminals are located, and an open position, which provides user access to the charging terminals. The structure of the foldable cover 304 of the battery compartment is shown in additional detail in FIGS. 3A through 4D. The cover 304 provides the following functions: preventing short circuit of the negative charging plates, preventing dust, dirt and debris from entering the battery compartment when the charger is not in use, and saving space when charger is not in use. In combination with the sliding negative charging plates, the foldable cover 304 provides for the battery charger 300 to have a smaller size. The location of the pivot point, and pivot axis, is indicated generally by reference number 334, and the shape of the cover 304 combine to effectively give the battery charger 300 greater length (from top to bottom) for receiving batteries when the cover is in the open position. In one embodiment, the cover 304 includes a cover front panel 333 and a cover end panel 335 join to form a generally “L” shape. In the open position, since the cover front panel then extends beyond the pivot axis, the cover provides room for the negative charging plates to slide and allow for location of the batteries in the charging terminals. When no batteries are placed in the battery charger 300, the negative charging plates are generally aligned with the pivot axis.

When the cover 304 is located in the open position, the cover 304 may serve the function of preventing short circuit by protecting the negative charging plates and reducing the chance of contact between one or more of the negative charging plates with an external conductor or a conductive material, which could result in a short circuit of the charging circuit 100. In the open position, the cover functions as a shield to the negative charging plates. In one embodiment, the cover front panel 333 and the cover end panel 335 function to shield the negative charging plates from at least two sides. In another embodiment, the shape of the cover may shield the negative charging plates from other angles, such as, for example, on side areas 337 of the cover 304. In another embodiment, the cover 304 may also include an additional panel to form a generally “U” shape to provide additional protection to the negative charging plates.

FIG. 4A is a perspective front view of the battery charger shown in FIG. 3A with the cover open and one AA size rechargeable battery placed in the battery charger, in accordance with an embodiment of the present invention. The battery charger 300 is shown having one AA size battery 336 located in the first charging area 310 of the battery charger 300.

FIG. 4B is a perspective front view of the battery charger shown in FIG. 3A with four AA size rechargeable batteries placed in the battery charger, in accordance with an embodiment of the present invention. The battery charger 300 is shown having four AA size batteries 338, one battery located in each of the first charging area 310, the second charging area 312, the third charging area 314, and the fourth charging area 316 of the battery charger 300.

FIG. 4C is a perspective front view of battery charger shown in FIG. 3A with the cover open and one AAA size rechargeable battery placed in the battery charger, in accordance with an embodiment of the present invention. The battery charger 300 is shown having one AAA size battery 340 located in the first charging area 310 of the battery charger 300.

FIG. 4D is a perspective front view of the battery charger shown in FIG. 3A with one AA size rechargeable battery and one AAA size rechargeable battery placed in the battery charger, in accordance with an embodiment of the present invention. The battery charger 300 is shown having one AA size battery 342 located in the first charging area 310 of the battery charger 300 and one AAA size battery 344 located in the second charging area 312 of the battery charger 300.

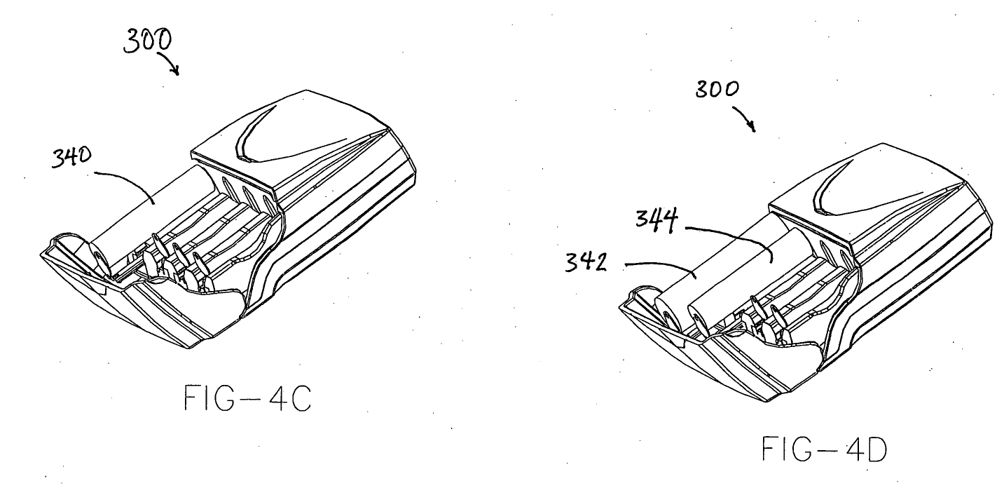

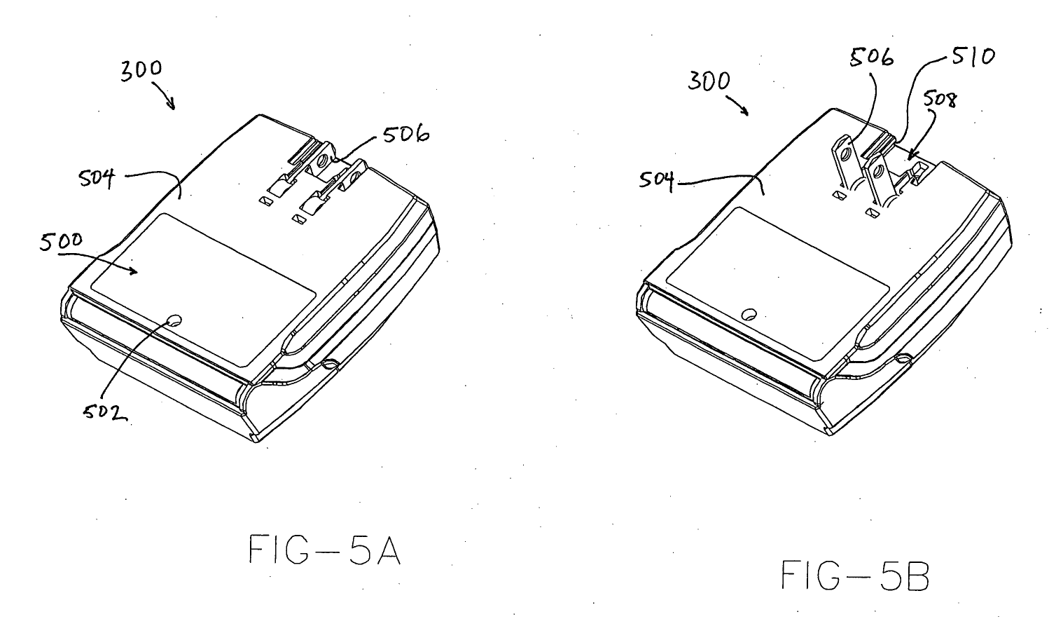

FIG. 5A is a perspective rear view of the battery charger shown in FIG. 3A with the AC plug 506 folded in a storage position, in accordance with an embodiment of the present invention. In one embodiment, the rear or rear panel of the battery charger 300 may have a label area 500 for providing details about the product. An opening 502 in the rear panel 504 may be used for receiving a screw (not shown) or rivet of other suitable connector for maintaining the rear panel 504 secured. However, any suitable way of constructing the battery charger 300 may be used, such as using hinges, notches, groves, indents, raised areas, adhesives, and the like. The AC plug 506, having two prongs and configured for use with North America standard outlets, is shown folded in a storage position.

FIG. 5B is a perspective rear view of the battery charger shown in FIG. 3A with the AC plug 506 unfolded into a use position, in accordance with an embodiment of the present invention. The AC plug 506 may be configured to pivot about an axis, over approximately 90 degrees, from the storage position to the use position. In the embodiment illustrated in FIGS. 5A and 5B, the two prong AC plug 506 is secured into the battery charger 300 with any suitable connectors (not shown). In the storage position, the AC plug 506 may be configured to receive a plug adapter (not shown). The two prongs of the plug may conductively connect with the plug adapter such that the plug adapter may be inserted into an electrical outlet and electrical current will be delivered from the electrical outlet to the plug adapter, from the plug adapter to the AC plug 506, and through the AC plug 506 to the charging circuit of the battery charger 300. In one embodiment, a recess 508 in the rear panel 504 provides room for the AC plug 506 in a storage position. The recess 508 may also have a pair of one or more side grooves 510 (only of the pair of groove(s) is visible) for receiving the plug adapter. However, any other suitable configuration for coupling the plug adapter to the battery charger may also be used.

FIG. 5C is a front view of the battery charger shown in FIG. 3A with the cover closed, in accordance with an embodiment of the present invention. A sectional line A-A is shown on the battery charger 300, running lengthwise from the top to the bottom of the battery charger.

FIG. 6A is a cross-sectional side view of the battery charger shown in FIG. 5C, taken along the section line A-A, showing the structure of the charging area without a battery placed in the battery charger, in accordance with an embodiment of the present invention. The operation of the charging plates as parts of the switches K1, K2, K3, K4, K5, K6, K7, and K8, described with reference to FIG. 1A, is illustrated with reference to FIGS. 6A through 6C. The cross sectional side views shown in FIGS. 6A through 6C show the configuration of one charging area. However, each of the charging areas may operate similarly. Also, in order to show the charging area clearly, the cover is not included in FIGS. 6A through 6C.

Referring now to FIG. 6A, the charging area is shown where no battery is inserted. The positive charging plate 600 is coupled to a printed circuit board (“PCB”) 601. In one embodiment, the positive charging plate 600 is directly affixed to the PCB 601 and is a part of the charging circuit. In one embodiment, the PCB includes at least some of the components of the charging circuit 100 illustrated in FIG. 1A. A negative charging plate 602 can slide in a longitudinal direction, from top to bottom. When no battery is located in the charging area, the negative charging plate 602 is in contact with the positive charging plate 600. The position of the negative charging plate 602 shown in FIG. 6A may be referred to as a contact position, or a first position. The contact position is also the “rest” position, when no external force is applied to the negative charging plate 602. A spring may be used for providing tension on the negative charging plate 602 so that (a) the negative charging plate 602 maintains contact with the positive charging plate 600, and (b) when the negative charging plate 602 is moved out of the contact position by an external force, the negative charging plate 602 returns to the contact position to contact the positive charging plate 600 after the external force is removed. Regardless of the position of the negative charging plate 602, a contact spring 604 remains in contact with the negative charging plate 602. The contact spring 604 conductively couples the negative charging plate 602 with the PCB 601 and therefore includes the negative charging plate 602 as part of the charging circuit. A detector spring 606 remains in contact with the negative charging plate 602 in the contact position, when no battery is inserted in the charging area and also when an AAA size battery is inserted into the charging area (as shown in FIG. 6C). The detector spring 606 is conductively coupled to the PCB 601 such that the detector spring 606 is part of the charging circuit. Each of the contact spring 604 and the detector spring 606 may be any type of suitable, conductive spring made from any suitable material. In one embodiment, each of the springs may be a leaf spring that is disposed against the negative charging plate 602, thereby capable of maintaining contact with the negative charging plate 602 when the negative charging plate is located proximate to the spring. In another embodiment, each of the springs may be a wire spring having similar qualities. In another embodiment, each of the springs may be a coil spring. In another embodiment, each of the springs may be replaced with any suitable contact element or component, such as a slidable connector that is conductive and performs generally the same function as the springs. Therefore, the detector spring and the contact spring may be referred to as the “detector element” and the “contact element,” respectively, as they need not necessarily be springs.

Assuming for the purposes of illustration that the charging area shown in FIGS. 6A, 6B, and 6C is associated with the first charging section of the charging circuit of FIG. 1A, the switch K1 includes the positive charging plate 600, the negative charging plate 602, and the contact spring 604. The switch K5 includes the negative charging plate 602, the contact spring 604, and the detector spring 606. Therefore, in the contact position, switch K1 is closed and switch K5 is closed. The correlation of the first charging section 116 to the illustrated charging area is for the purposes of illustration. However, it can be seen how each charging area of the battery charger 300 operates, similar to the operation described with reference to FIGS. 6A, 6B, and 6C, in conjunction with the charging circuit shown in FIG. 1A.

FIG. 6B is a cross-sectional side view of the battery charger shown in FIG. 5C, taken along the section line A-A, showing the structure of the charging area with an AA size battery 610 placed in the battery charger, in accordance with an embodiment of the present invention. The position of the negative charging plate 602 shown in FIG. 6B may be referred to as an AA position, or a second position.

In order for a battery of any size to be inserted into the charging area, the negative charging plate 602 is slid longitudinally away from the positive charging plate 600. When the AA size battery 610 is located between the negative charging plate 602 and the positive charging plate 600, the negative charging plate 602 contacts the negative end of the AA battery 610, and the positive charging plate 600 contacts the positive terminal of the AA battery 610. In FIG. 6B it can be seen that the negative charging plate 602 is not in contact with the positive charging plate 600. Therefore, when the negative charging plate 602 is in the AA, or second, position, switch K1 is open. It can also be seen that, due to the length of the AA battery 610 and the fixed position of the detector spring 606, the negative charging plate 602 is also not in contact with the detector spring 606. Therefore, when the negative charging plate 602 is in the AA, or second, position, switch K5 is also open. Accordingly, both switch K1 and switch K5 are open when the negative charging plate 602 is in the AA, or second, position.

FIG. 6C is a cross-sectional side view of the battery charger shown in FIG. 5C, taken along the section line A-A, showing the structure of the charging area with an AAA size battery placed in the battery charger, in accordance with an embodiment of the present invention. The position of the negative charging plate 602 shown in FIG. 6C may be referred to as an AAA position, or a third position. When the AAA battery 612 is located in the charging area, the negative charging plate 602 is slid longitudinally away from the positive charging plate 600. When the AAA size battery 612 is located between the negative charging plate 602 and the positive charging plate 600, the negative charging plate 602 contacts the negative end of the AAA battery 612 and the positive charging plate 600 contacts the positive terminal of the AAA battery 612. In FIG. 6C it can be seen that the negative charging plate 602 is not in contact with the positive charging plate 600. Therefore, when the negative charging plate 602 is in the AAA, or third, position, switch K1 is open. Because the length of the AAA battery 612 is shorter than the length of the AA battery 610, the negative charging plate 602 is not moved as far away from the positive charging plate 600 as it is when the AA battery 601 is located in the charging area. Therefore, as can be seen in FIG. 6C, due to the length of the AAA battery 612 and the fixed position of the detector spring 606, the negative charging plate 602 remains in contact with the detector spring 606. Therefore, when the negative charging plate 602 is in the AAA, or third, position, switch K5 is closed. Accordingly, switch K1 is open and switch K5 is closed when the negative charging plate 602 is in the AAA, or third, position.

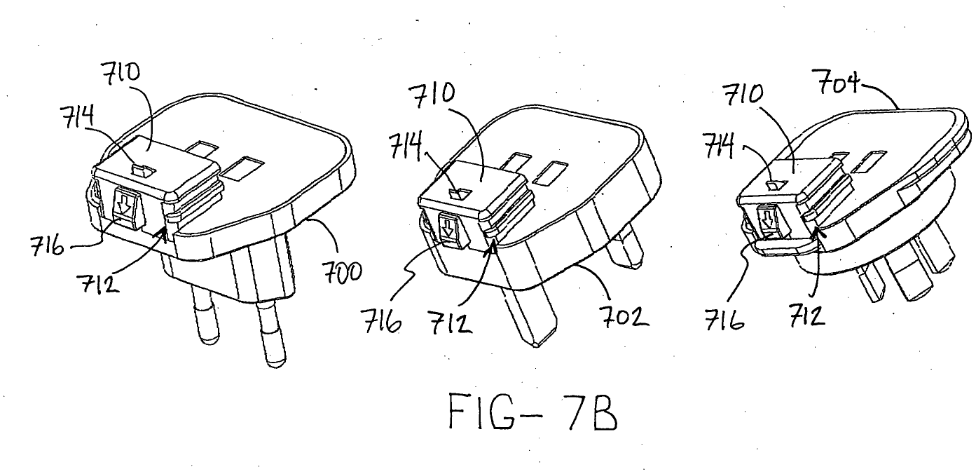

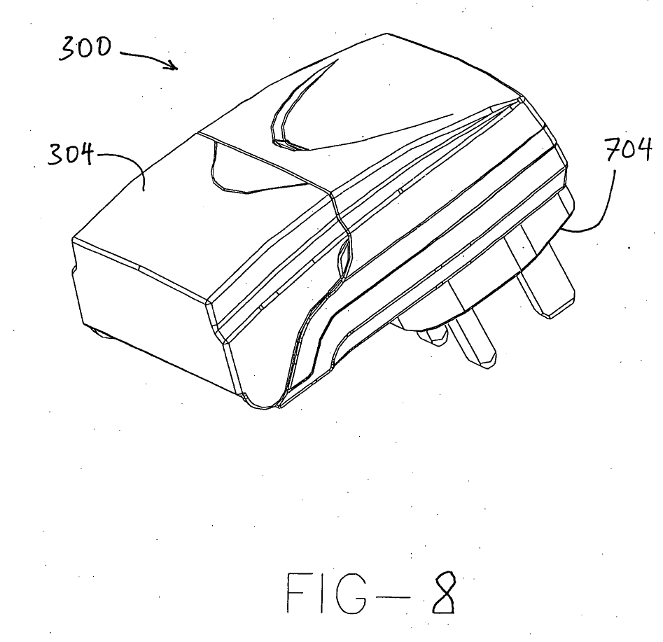

FIG. 7A is a perspective front view of multiple AC plug adapter configurations for use with the battery charger shown in FIG. 3A, in accordance with an embodiment of the present invention. A Europe plug adapter 700, an Australia plug adapter 702, and a United, Kingdom plug adapter 704 are shown. Each of the plug adapters may be selectively, removably connected to the battery charger 300. In another embodiment, any one of the plug configurations may be integrated into the battery charger 300.

FIG. 7B is a perspective rear view of multiple AC plug adapter configurations for use with the battery charger shown in FIG. 3A, in accordance with an embodiment of the present invention. The Europe plug adapter 700, the Australia plug adapter 702, and the United Kingdom plug adapter 704 are shown. Each of the illustrated plug adapters includes an attachment block 710 for removable attachment to the battery charger. As described above with reference to FIGS. 5A and 5B, the recess 508 configured to receive the attachment block 710. Each attachment block 710 includes a pair of one or more grooves 712 (only one of the pair is shown). The pair of one or more grooves 712 is configured to complement and engage the pair of one or more side grooves 510 in the recess 508 of the rear panel 504 (shown in FIG. 5B). The AC plug 506 slides into the attachment block 710 to create a conductive connection between the AC plug 506 and the plug adapter being attached to the battery charger. Other suitable attachment methods may be used. Each of the plug adapters may include a locking latch 714 which secures the attachment block 710 in place, the locking latch 714 received into a notch (not shown) in the recess 508 of the rear panel 504. A release button 716 removes the locking latch 714 from the notch so that the attachment block 710 may be removed from the battery charger.

FIG. 8 is a perspective front view of the battery charger shown in FIG. 3A with the UK plug adapter attached, in accordance with an embodiment of the present invention. The battery charger 300 is shown with the UK plug adapter 704 attached and the cover 304 in the closed position.

Those skilled in the art will appreciate that the above-described system may be implemented in a variety of configurations. For example, while certain types of circuit components have been described, other suitable components may be used. Additionally, which the battery charger has been described with reference to AA size and AAA size batteries, the principles described herein may be similarly applied to batteries of other sizes.

The previous description of the exemplary embodiments is provided to enable any person skilled in the art to make and/or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

What is claimed is:

1. A battery charger for charging one or more rechargeable batteries, the battery charger comprising:
a charger body;
one or more charging channels in the charger body, each of the one or more charging channels having a positive charging plate and a negative charging plate, each of the one or more charging channels configured to receive a battery between the positive charging plate and the negative charging plate such that the positive charging plate contacts the positive terminal of the battery and the negative charging plate contacts the negative terminal of the battery; and
a charging circuit coupled to the positive charging plate and the negative charging plate of each of the one or more charging channels, the charging circuit configured to provide a charging current through the positive charging plate and the negative charging plate of each charging channel, the charging circuit further including a microcontroller configured to receive a detection signal and adjust the charging current in response to the detection signal.

2. The battery charger of claim 1, wherein the charger body includes at least two charging channels and the charging circuit includes at least two circuit channels in series having a common current control switch.

3. The battery charger of claim 2, wherein the at least two circuit channels correspond one-to-one to the two or more charging channels of the charger body.

4. The battery charger of claim 1, wherein the negative charging plate of each charging channel is selectively slidable between a first position, a second position, and a third position.

5. The battery charger of claim 4, wherein the negative charging plate of each charging channel is in the first position when no battery is located in the charging channel, in the second position when an AA size battery is located in the charging channel, and in the third position when an AAA size battery is located in the charging channel, and wherein the detection signal is generated when the negative charging plate of at least one of the one or more charging channels is in the third position.

6. The battery charger of claim 1, wherein a voltage change occurs in the charging circuit when a AAA size battery is located in the charging channel, and the detection signal includes the voltage change.

7. The battery charger of claim 1, wherein the detection signal is generated by a voltage change in the charging circuit.

8. The battery charger of claim 1, wherein the detection signal is received by the microprocessor in response to a voltage change in the charging circuit.

9. The battery charger of claim 1, wherein the detection signal includes detecting a voltage change in the charging circuit.

10. A battery charger for charging one or more rechargeable batteries, the battery charger comprising:
a charger body;
two or more charging channels in the charger body, each of the two or more channels having a positive charging plate and a negative charging plate, each of the two or more channels configured to receive a battery between the positive charging plate and the negative charging plate such that the positive charging plate contacts the positive terminal of the battery and the negative charging plate contacts the negative terminal of the battery, the negative charging plate slidable between a first position, a second position, and a third position; and
a charging circuit coupled to the positive charging plate and the negative charging plate of each of the two or more charging channels, the charging circuit configured to provide a charging current through the positive charging plate and the negative charging plate of each channel, the charging circuit further including a microcontroller configured to configured to receive a detection signal and adjust the charging current in response to the detection signal, the charging circuit further including two or more detector elements corresponding one-to-one to the two or more charging channels of the charger body, each of the detector elements in separable contact with a corresponding negative charging plate, wherein the detection signal is generated when contact between at least one of the corresponding detector element and negative charging plate is separated.

11. The battery charger of claim 10, wherein the charging circuit further includes two or more circuit channels in series having a common current control switch, the two or more circuit channels corresponding one-to-one to the two or more charging channels of the charger body.

12. The battery charger of claim 10, wherein the negative charging plate of each charging channel is in the first position when no battery is located in the charging channel, in the second position when an AA size battery is located in the charging channel, and in the third position when an AAA size battery is located in the charging channel, and wherein the contact between at least one of the corresponding detector element and negative charging plate is separated when the negative charging plate is in the third position.

13. The battery charger of claim 12, wherein a voltage change occurs when the contact between the at least one of the corresponding detector element and negative charging plate is separated.

14. The battery charger of claim 10, wherein the detection signal includes detecting a voltage change in the charging circuit.

15. A battery charger for charging one or more rechargeable batteries, the battery charger comprising:
a charger body;
one or more charging channels in the charger body, each of the one or more charging channels having a positive charging plate and a negative charging plate, wherein the negative charging plate of each charging channel is selectively slidable between a first position, a second position, and a third position; and
a charging circuit coupled to the positive charging plate and the negative charging plate of each of the one or more charging channels, the charging circuit configured to provide a charging current through the positive charging plate and the negative charging plate of each charging channel, the charging circuit further including a microcontroller configured to receive a detection signal and adjust the charging current in response to the detection signal; and
a cover coupled to the charger body, the cover pivotable between an open position and a closed position, wherein in the closed position the cover forms an enclosure with the charger body, the positive charging plate and the negative charging plate of each of the one or more charging channels within the enclosure.

16. The battery charger of claim 15, wherein in the open position, a panel of the cover extends longitudinally beyond a pivot axis of the cover.

17. The battery charger of claim 15, wherein in the open position, the negative charging plate of each charging channel is longitudinally slidable beyond a pivot axis of the cover.

18. The battery charger of claim 17, wherein in a rest position the negative charging plate of each charging channel is approximately aligned with a pivot axis of the cover.

19. The battery charger of claim 17, wherein the cover includes a front panel and an end panel, and wherein in an open position the front panel longitudinally extends beyond the pivot axis.

20. The battery charger of claim 15, wherein the cover is a shield from external contact with the negative charging plate of each charging channel.

21. A battery charger for charging one or more rechargeable batteries, the battery charger comprising:
a charger body having an AC plug for coupling to an electrical outlet;
one or more charging channels in the charger body, each of the one or more charging channels having a positive charging plate and a negative charging plate; and
a charging circuit coupled to the positive charging plate and the negative charging plate of each of the one or more charging channels, the charging circuit configured to provide a charging current through the positive charging plate and the negative charging plate of each charging channel, the charging circuit further including a microcontroller configured to receive a detection signal and adjust the charging current in response to the detection signal; and
one or more plug adapters configured for alternative coupling to the AC plug, wherein each of the one or more plug adapters is alternatively electrically connected to the AC plug.

22. The battery charger of claim 21, wherein the AC plug is pivotable between a use position and a storage position, wherein the AC plug protrudes from the charger body for coupling to the electrical outlet in the use position, and wherein the AC plug is located within a recess in the charger body in the storage position, and the AC plug further configured to receive alternative connection to the one or more plug adapters in the storage position

23. The battery charger of claim 21, the charger body further including a recess proximate to the AC plug, wherein the recess is configured for slidable attachment with the one or more plug adapters

24. The battery charger of claim 21, wherein the recess includes one or more grooves and the one or more plug adapters each include one or more grooves corresponding to the one or more grooves of the recess, the one or more plug adapters further including a locking latch and a release button

25. A battery charger for charging one or more rechargeable batteries, the battery charger comprising:
a charger body;
two or more charging channels in the charger body, each of the two or more channels having a positive charging plate and a negative charging plate, each of the two or more channels configured to receive a battery between the positive charging plate and the negative charging plate such that the positive charging plate contacts the positive terminal of the battery and the negative charging plate contacts the negative terminal of the battery, the negative charging plate slidable between a first position, a second position, and a third position, wherein the negative charging plate of each charging channel is in the first position when no battery is located in the charging channel, in the second position when an AA size battery is located in the charging channel, and in the third position when an AAA size battery is located in the charging channel; and
a charging circuit coupled to the positive charging plate and the negative charging plate of each of the two or more charging channels, the charging circuit configured to provide a charging current through the positive charging plate and the negative charging plate of each channel, the charging circuit further including a microcontroller configured to detect a voltage change in the charging circuit and adjusting the charging current in response to the detection of the voltage change, the charging circuit further including two or more detector elements corresponding one-to-one to the two or more charging channels of the charger body, each of the detector elements in separable contact with a corresponding negative charging plate, wherein the voltage change in the charging circuit occurs when contact between at least one of the corresponding detector element and negative charging plate is separated, the contact being separated when the negative charging plate is in the third position, the charging circuit further including two or more circuit channels in series having a common current control switch, the two or more circuit channels corresponding one-to-one to the two or more charging channels of the charger body.

26. A battery charger for charging one or more rechargeable batteries, the battery charger comprising:
a charger body having means for receiving one or more batteries;
means for delivering a charging current to the one or more batteries in series, the delivery means including a control means for controlling the delivery of the charging current to the two or more batteries;
means for detecting the presence of an AAA size battery in the battery charger; and
means for adjusting the charging current delivered to the one or more batteries in response to detecting the presence of an AAA size battery in the battery charger

27. The battery charger of claim 26, further including means for connecting the battery charger to an electrical outlet, the connecting means further configured for alternately receiving one or more plug adapters

28. The battery charger of claim 26, further including means for covering the delivering means, wherein the covering means includes a first position configured to prevent location of the one or more batteries in the charger body, and wherein the covering means includes a second position configured to allow location of the one or more batteries in the charger body
